(19) United States
(12) Patent Application Publication
(10) Pub. No.: US 2024/0201613 A1
(43) Pub. Date: Jun. 20, 2024

(54) COLOR IMAGE FORMING APPARATUS

(71) Applicant: Masatoshi MURAKAMI, Kanagawa (JP)

(72) Inventor: Masatoshi MURAKAMI, Kanagawa (JP)

(21) Appl. No.: 18/540,923

(22) Filed: Dec. 15, 2023

(30) Foreign Application Priority Data
Dec. 20, 2022 (JP) 2022-203605

(51) Int. Cl. G03G 15/04; G03G 15/00; G03G 15/043

(52) U.S. Cl. CPC G03G 15/04036; G03G 15/043; G03G 15/6564; G03G 2215/00599; G03G 2215/0158

(57) ABSTRACT

An electrophotographic color image forming apparatus develops an electrostatic latent image with a developer to form an image and includes a photoconductor and an optical writing device. The writing device includes a light-emitting element, a light emission control element, a deflector element, a synchronization detection element, a memory, and processing circuitry. The memory stores a first light amount of the light-emitting element when a color shift is corrected. The processing circuitry corrects the color shift by adjusting a write start timing, and corrects a detection shift generated when a light amount of light incident on the synchronization detection element fluctuates. The processing circuitry calculates a detection shift correction value of the detection shift of the synchronization detection element, using the first light amount and a second light amount determined as a lighting condition of the light-emitting element, and adds the detection shift correction value to a color shift correction value.

### CROSS-REFERENCE TO RELATED APPLICATION

This patent application is based on and claims priority pursuant to 35 U.S.C. § 119(a) to Japanese Patent Application No. 2022-203605, filed on Dec. 20. 2022, in the Japan Patent Office, the entire disclosure of which is hereby incorporated by reference herein.

### BACKGROUND

### Technical Field

Embodiments of the present disclosure relate to a color image forming apparatus.

### Related Art

In an electrophotographic image forming apparatus, particularly in a configuration in which a photoconductor is exposed by a light-emitting element such as a laser diode (LD), a beam (light) outputted from the LD is reflected by a rotating polygon mirror (an example of a polarizing element). In the electrophotographic image forming apparatus, when the beam of the LD is emitted from end to end of one surface of the polygon mirror, the beam is deflected according to the angle of the polygon mirror, and one line's worth is scanned on the photoconductor. At this time, the electrophotographic image forming apparatus forms, on the photoconductor, one line's worth of an electrostatic latent image by switching the LD on and off according to inputted image data. The electrophotographic image forming apparatus then forms an electrostatic latent image of a desired image by repeating line scanning corresponding to one line (line scanning) on the photoconductor while rotating the photoconductor.

In an electrophotographic image forming apparatus, when line scanning is repeated, it is necessary to match a write start timing for starting the image formation. In the electrophotographic image forming apparatus, in order to determine the write start timing, a light sensor is provided immediately before a beam scanning position for scanning the photoconductor, and the beam scanning position is detected. This light sensor is referred to as a synchronization detection sensor (synchronization detection element). The electrophotographic image forming apparatus determines an image data write start timing according to an output signal of the synchronization detection sensor.

Here, the light sensor is a photodiode that uses an amplifier and a gain resistor to detect a minute current change. The photodiode determines the presence or absence of a beam input according to this current change. Although a circuit may also be made by combining elements of a photodiode, a photo integrated circuit (IC) in which a slit or a cover glass is provided to improve and stabilize the beam detection accuracy is commercially available, and may be implemented at low cost.

An electrophotographic image forming apparatus changes a light amount of a beam according to image forming conditions for an image. The image forming conditions for changing the light amount of the beam include a change in productivity (linear velocity), a change in temperature environment, and the like, in addition to a change of the resolution of the output image. When an image forming conditions for changing the light amount of the beam is changed, the light amount of the beam inputted to the synchronization detection sensor also changes. When the light amount of the beam changes, the magnitude of the current flowing through the synchronization detection sensor changes, and the detection waveform of the synchronization detection sensor changes. When the detection waveform of the synchronization detection sensor changes, the image data write start timing is shifted to cause a positional shift in the scanning direction (main-scanning direction). Because the positional shift is about several 10 ns, there is no disadvantage if there is a single color as in the case of a monochrome machine, but in the case of a color machine, a change in color tone or color shift occurs, and the image quality is degraded.

### SUMMARY

According to an embodiment of the present disclosure, an electrophotographic color image forming apparatus develops an electrostatic latent image with a developer to form an image. The electrophotographic color image forming apparatus includes a photoconductor to bear the electrostatic latent image to be developed with the developer and an optical writing device to expose the photoconductor. The optical writing device includes a light-emitting element, a light emission control element, a deflector element, a synchronization detection element, a memory, and processing circuitry. The light-emitting element irradiates the photoconductor with light. The light emission control element controls light emission of the light-emitting element. The deflector element is a multifaceted reflector disposed on an emission light path of the light from the light-emitting element. The reflector is rotated by a signal inputted from an external device and deflects the light with which a surface of the reflector is irradiated to scan the photoconductor with the light in one direction. The synchronization detection element detects a write start timing of the electrostatic latent image with the light with which the photoconductor is irradiated. The memory stores an execution condition for correcting a color shift between a plurality of colors and a color shift correction value for correcting the color shift. The memory stores a first light amount of the light-emitting element when the color shift is corrected. The processing circuitry corrects the color shift by adjusting the write start timing from when the synchronization detection element detects light to when light emission control by the light emission control element according to image data is started, and corrects a detection shift generated when a light amount of light incident on the synchronization detection element fluctuates. The processing circuitry calculates a detection shift correction value of the detection shift of the synchronization detection element, using the first light amount and a second light amount determined as a lighting condition of the light-emitting element, and adds the detection shift correction value to the color shift correction value.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a diagram illustrating a configuration of a color image forming apparatus according to a first embodiment of the present disclosure;

FIG. 1B is a diagram illustrating a hardware configuration of a multi-function peripheral/product/printer (MFP) to which the color image forming apparatus according to the first embodiment is applied;

FIG. 2 is a block diagram illustrating an example of a functional configuration of an optical writing device included in the color image forming apparatus according to the first embodiment;

FIG. 3 is a diagram illustrating an example of correction processing of a write start timing in the color image forming apparatus according to the first embodiment;

FIG. 4 is a diagram illustrating an example of a synchronization detection plate included in the color image forming apparatus according to the first embodiment;

FIG. 5 is a diagram illustrating an example of a configuration of an optical writing device included in the color image forming apparatus according to the first embodiment;

FIG. 6A is a diagram illustrating an example of light incident on a toner marking (TM) sensor of the color image forming apparatus according to the first embodiment;

FIG. 6B is a graph illustrating an example of a signal outputted from the TM sensor of the color image forming apparatus according to the first embodiment;

FIG. 7 is a graph illustrating an example of the relationship between the intensity of the light with which the TM sensor of the color image forming apparatus according to the first embodiment is irradiated, a detection signal, and an output signal;

FIG. 8 is a diagram illustrating a configuration of an optical writing device included in the color forming apparatus according to the first embodiment;

FIG. 9A is a diagram illustrating an example of the light incident on the TM sensor of the color image forming apparatus according to the first embodiment;

FIG. 9B is a graph illustrating an example of the signal outputted from the TM sensor of the color image forming apparatus according to the first embodiment;

FIG. 10 is a graph illustrating an example of the signal outputted from the TM sensor of the color image forming apparatus according to the first embodiment;

FIG. 11A is a diagram illustrating an example of the light incident on the TM sensor of the color image forming apparatus according to the first embodiment;

FIG. 11B is a graph illustrating an example of the signal outputted from the TM sensor of the color image forming apparatus according to the first embodiment;

FIG. 11C is a graph illustrating an example of a change in a write start timing in the color image forming apparatus according to the first embodiment;

FIGS. 12A and 12B are diagrams illustrating an example of a write start timing correction table included in the color image forming apparatus according to the first embodiment;

FIG. 13 is a diagram illustrating an example of a method in which a correction table in the color image forming apparatus according to the first embodiment is used;

FIG. 14A is a flowchart illustrating an example of a flow of color matching processing in the color image forming apparatus according to the first embodiment;

FIG. 14B is a flowchart illustrating an example of a flow of a print operation in the color image forming apparatus according to the first embodiment; and

FIG. 15 is a diagram illustrating an example of a method for correcting a write start timing in the color image forming apparatus according to a second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below As used herein, the singular forms “a,” “an,” and “the” are intended to include the plural forms as well, unless the context clearly indicates otherwise.

Hereinafter, embodiments of a color image forming apparatus will be described in detail with reference to the accompanying drawings.

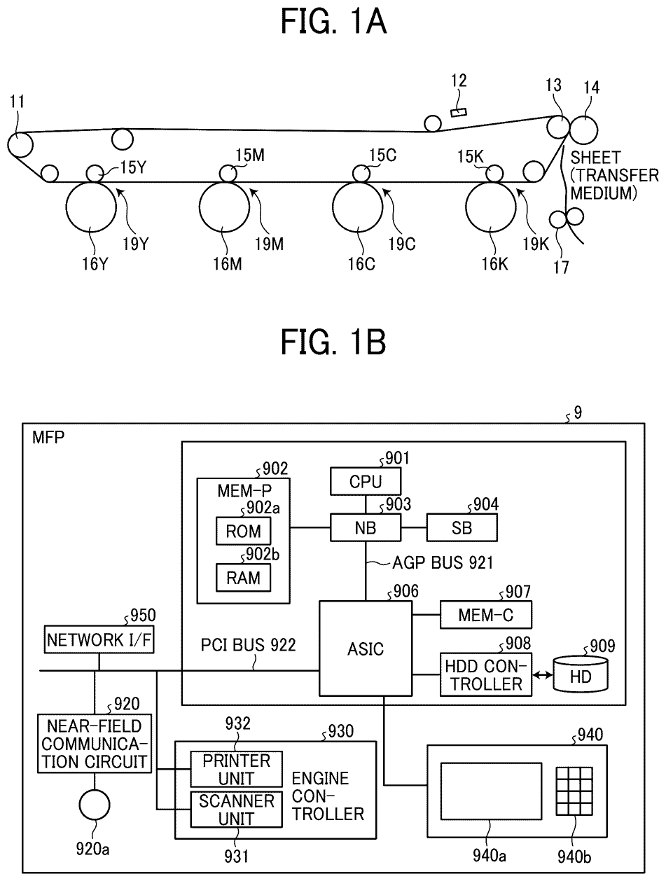

FIG. 1A is a diagram illustrating an example of a configuration of a color image forming apparatus according to a first embodiment. The color image forming apparatus is an example of a color image forming apparatus that forms an image by using a developer to develop an electrostatic latent image on a photoconductor and that forms the image on a recording sheet conveyed by a registration roller pair or the like.

As illustrated in FIG. 1A, the color image forming apparatus according to the present embodiment includes primary transfer rollers 15K, 15C, 15M, and 15Y, photoconductors 16K, 16C, 16M, and 16Y, an intermediate transfer belt 18, a tension roller 11, a toner marking sensor (hereinafter referred to as a TM sensor) 12, a driving roller 13, and a secondary transfer roller 14. In the following description, in a case where no distinction is made between the primary transfer rollers 15K, 15C, 15M, and 15Y, same are referred to as the primary transfer rollers 15. Furthermore, in the following description, in a case where no distinction is made between the photoconductors 16K, 16C, 16M, and 16Y, same are referred to as the photoconductors 16.

The photoconductors 16K, 16C, 16M, and 16Y are arranged along the intermediate transfer belt 18 in the order of the photoconductors 16K, 16C, 16M, and 16Y from the upstream side in the conveyance direction of the intermediate transfer belt 18.

A charger, a developing device, the primary transfer roller 15K, a photoconductor cleaner, a static eliminator, and the like, are arranged around the photoconductor 16K. In the following description, the photoconductor 16K, the charger, the developing device, the primary transfer roller 15K, the photoconductor cleaner, the static eliminator, and the like, are collectively referred to as an image forming unit 19K.

Note that, for all of the photoconductors 16C, 16M, and 16Y, components common to the photoconductor 16K are arranged around the photoconductors, In the following description, the photoconductor 16C, the charger, the developing device, the primary transfer roller 15C, the photoconductor cleaner, the static eliminator, and the like are collectively referred to as an image forming unit 19C. The photoconductor 16M, the charger, the developing device, the primary transfer roller 15M, the photoconductor cleaner, the static eliminator, and the like are collectively referred to as an image forming unit 19M. The photoconductor 16Y the charger, the developing device, the primary transfer roller 15Y, the photoconductor cleaner, the static eliminator, and the like are collectively referred to as an image forming unit 19Y.

In the present embodiment, in a case where color image formation is to be performed, as illustrated in FIG. 1A, the photoconductors 16K, 16C, 16M, and 16Y abut on the intermediate transfer belt 18, and in a case where monochrome image formation is to be performed, the photoconductor 16K abuts on the intermediate transfer belt 18, and the photoconductors 16C, 16M, and 16Y are separated from the intermediate transfer belt 18.

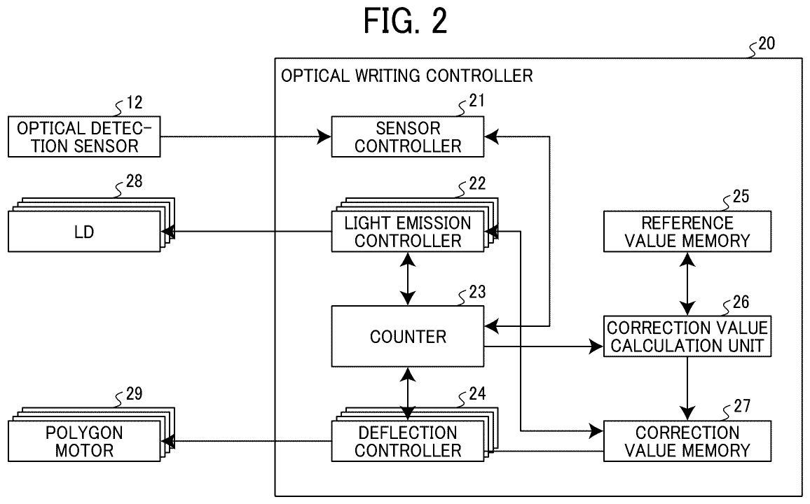

Then, the image forming unit 19K and a laser diode (LD) 28 (see FIG. 2), which is an example of a light-emitting element, perform an image forming process (charging step, exposure step, developing step, transfer step, cleaning step, and non-charging step) in a state where the photoconductor 16K is in contact with the intermediate transfer belt 18, thereby forming a black toner image (an example of an image) on the intermediate transfer belt 18.

Similarly, the image forming unit 19C and the LD 28 form a cyan toner image on the intermediate transfer belt 18 by performing an image forming process in a state where the photoconductor 16C is in contact with the intermediate transfer belt 18. The image forming unit 19M and the LD 28 form a magenta toner image on the intermediate transfer belt 18 by performing an image forming process in a state where the photoconductor 16M is in contact with the intermediate transfer belt 18. The image forming unit 19Y and the LD 28 form a yellow toner image on the intermediate transfer belt 18 by performing an image forming process in a state where the photoconductor 16Y is in contact with the intermediate transfer belt 18.

That is, in the present embodiment, in the case of forming a color image, the photoconductors 16K, 16C, 16M, and 16Y perform an image forming process, but in the case of forming a monochrome image, the photoconductor 16K performs the image forming process but the photoconductors 16C, 16M, and 16Y do not perform the image forming process.

Hereinafter, the image forming process by the image forming unit 19K will be mainly described, and the description of the image forming process by the image forming rants 19C, 19M, and 19Y will be omitted.

The photoconductor 16K is rotationally driven by a drive motor.

First, in the charging step, the charger uniformly charges, in the dark, the outer peripheral surface of the rotationally driven photoconductor 16K.

Subsequently, in the exposure step, the LD 28 exposes the outer peripheral surface of the rotationally driven photoconductor 16K with emitted light (Bk) corresponding to a black image, and forms, on the photoconductor 16K, an electrostatic latent image based on the black image.

Thereafter, in the developing step, the developing device uses black toner to develop the electrostatic latent image on the photoconductor 16K, and forms a black toner image on the photoconductor 16K.

Subsequently, in the transfer step, the primary transfer roller 15K transfers the black toner image on the photoconductor 16K to the intermediate transfer belt 18 in a primary transfer position in contact with the photoconductor 16K. Note that a little untransferred toner remains on the photoconductor 16K even after the toner image is transferred.

Subsequently, in the cleaning process, the photoconductor cleaner wipes the untransferred toner remaining on the photoconductor 16K.

Finally, in the static elimination step, the static eliminator eliminates the residual potential on the photoconductor 16K. The photoconductor 16K then waits for the next image formation.

The intermediate transfer belt 18 is an endless belt wound around the tension roller 11 and the driving roller 13, and moves endlessly in the order of the photoconductors 16K, 16C, 16M, and 16Y as a result of the driving roller 13 being rotationally driven by the drive motor.

As illustrated in FIG. 1A, in a case where color image formation is to be performed, a black toner image is first transferred to the intermediate transfer belt 18 by the photoconductor 16K, and then a cyan toner image, a magenta toner image, and a yellow toner image are superimposed and transferred by the photoconductor 16C, the photoconductor 16M, and the photoconductor 16Y, respectively. As a result, a full-color image is formed on the intermediate transfer belt 18.

In a case where monochrome image formation is to be performed, a black toner image is transferred to the intermediate transfer belt 18 by the photoconductor 16K. As a result, a monochrome image is formed on the intermediate transfer belt 18.

Further, when the image on the intermediate transfer belt 18 is conveyed to the secondary transfer position in contact with the driving roller 13, the secondary transfer roller 14 presses the recording sheet conveyed by a registration roller pair 17 or the like against the image on the intermediate transfer belt 18 in the secondary transfer position. As a result, the image is transferred from the intermediate transfer belt 18 to the recording sheet.

The tension roller 11 applies tension to the intermediate transfer belt 18 to absorb all the extension of the intermediate transfer belt 18 due to the influence of temperature change. That is, in the present embodiment, the intermediate transfer belt 18 does not uniformly extend due to the influence of the temperature change, but the extension of the intermediate transfer belt 18 due to the influence of the temperature change is concentrated on the tension roller 11 portion.

Here, in the present embodiment, the tension roller 11 is disposed on the path from the primary transfer position where the intermediate transfer belt 18 is located most downstream (the primary transfer position where the photoconductor 16Y and the primary transfer roller 15Y are in contact with each other) to the TM sensor 12.

Therefore, according to the present embodiment, if the influence of the temperature change is the same, the amount of expansion of the intermediate transfer belt 18 at the conveyance distance of the image by the intermediate transfer belt 18 (from the primary transfer position, where the photoconductor 16Y and the primary transfer roller 15Y are in contact with each other, to the secondary transfer position) in a case where color image formation is to be performed, and the amount of expansion of the intermediate transfer belt 18 at the conveyance distance of the image by the intermediate transfer belt 18 (from the primary transfer position, where the photoconductor 16K and the primary transfer roller 15K are in contact with each other, to the secondary transfer position) in a case where monochrome image formation is to be performed have a common value.

The TM sensor 12 is an example of a synchronization detection element that detects the write start timing of the electrostatic latent image by irradiating the photoconductors 16 with light. Specifically, the TM sensor 12 is a photosensor or the like, and detects the write start timing by reading the positional shift correction pattern formed on the intermediate transfer belt 18. In the present embodiment, as illustrated in FIG. 1A, in a case where color image formation is to be performed, positional shift correction patterns of four colors are formed on the intermediate transfer belt 18 by the photoconductors 16K, 16C, 16M, and 16Y, and in a case where monochrome image formation is to be performed, a positional shift correction pattern of one monochrome color is formed on the intermediate transfer belt 18 by the photoconductor 16K.

FIG. 1B is a diagram illustrating an example of a hardware configuration of an MFP to which the color image forming apparatus according to the first embodiment is applied. As illustrated in FIG. 1B, a multi-function peripheral/product/printer (MFP) 9 includes a controller 910. a near-field communication circuit 920, an engine controller 930, an operation panel 940, and a network interface (I/F) 950.

Among these components, the controller 910 includes a central processing unit (CPU) 901 which is a main part of a computer, a system memory (MEM-P) 902, a north bridge (NB) 903, a south bridge (SB) 904, an application specific integrated circuit (ASIC) 906, a local memory (MEM-C) 907 which is a memory, a hard disk drive (HDD) controller 908, and a hard disk (HD) 909 which is a memory, and the NB 903 and the ASIC 906 are interconnected by an accelerated graphics port (AGP) bus 921.

Among these components, the CPU 901 is a control unit that performs overall control of the MFP 9. The NB 903 is a bridge for connecting the CPU 901, the MEM-P 902, the SB 904, and the AGP bus 921, and includes a memory controller that controls reading and writing from and to the MEM-P 902, a peripheral component interconnect (PCI) master, and an AGP target.

The MEM-P 902 includes a read only memory (ROM) 902a which is a memory for storing a program and data for implementing each function of the controller 910, and a random access memory (RAM) 902b which is used as a drawing memory or the like at the time of developing the program and the data and memory printing. Note that the program stored in the RAM 902b may be provided by being recorded on a computer-readable recording medium such as a compact disc read only memory (CD-ROM), a compact disk recordable (CD-R), or a digital versatile disc (DVD) as a file in an installable format or an executable format.

The SB 904 is a bridge for connecting the NB 903 to a PCI device and a peripheral device. The ASIC 906 is an integrated circuit (IC) for image processing having a hardware element for image processing, and serves as a bridge that connects the AGP bus 921, a PCI bus 922, the HDD 908, and the MEM-C 907. The ASIC 906 includes a PCI target, an AGP master, an arbiter (ARB) that forms the core of the ASIC 906, a memory controller that controls the MEM-C 907, a plurality of direct memory access controllers (DMACs) that rotates image data by means of hardware logic or the like, and a PCI unit that performs data transfer between the scanner unit 931 and the printer unit 932 via the PCI bus 922. Note that a universal serial bus (USB) interface or an Institute of Electrical and Electronics Engineers 1394 (IEEE 1394) interface may be connected to the ASIC 906. In the present embodiment, the printer unit 932 has a configuration of a color image forming apparatus illustrated in FIG. 1A.

The MEM-C 907 is a local memory used as a copy image buffer and a code buffer. The HD 909 is storage for accumulating image data, accumulating font data used at the time of printing, and accumulating forms. The HD 909 controls reading or writing of data from/to the HD 909 under the control of the CPU 901. The AGP bus 921 is a bus interface for graphics accelerator card proposed for speeding up graphics processing, and may speed up the graphics accelerator card by directly accessing the MEM-P 902 with high throughput.

The near-field communication circuit 920 includes a near-field communication circuit 920a. The near-field communication circuit 920 is a communication circuit such as a near-field communication (NFC) or Bluetooth (registered trademark) communication circuit.

Furthermore, the ermine controller 930 includes a scanner unit 931 and a printer unit 932. In addition, the operation panel 940 includes a panel display unit 940a such as a touch panel that displays current setting values, a selection screen, and the like and receives inputs from an operator, and an operation panel 940b including a numeric keypad that receives setting values for image formation-related conditions such as a density setting condition, a start key that receives a copy start instruction, and the like. The controller 910 controls the entire MFP 9, and controls drawing, communication, inputs from the operation panel 940, and the like, for example. The scanner unit 931 or the printer unit 932 includes an image processing parts such as error diffusion and gamma conversion parts.

Note that the MFP 9 enables sequential switching and selection of a document box function, a copy function, a printer function, and a facsimile function by means of an application switching key of the operation panel 940. A document box mode is set when the document box function is selected, a copy mode is set when the copy function is selected, a printer mode is set when the printer function is selected, and a facsimile mode is set when the facsimile mode is selected.

Furthermore, the network I/F 950 is an interface that uses a communication network 100 to perform data communication. The near-field communication circuit 920 and the network I/F 950 are electrically connected to the ASIC 906 via the PCI bus 922.

FIG. 2 is a block diagram illustrating an example of a functional configuration of an optical writing device included in the color image forming apparatus according to the first embodiment. The optical writing device included in the color image forming apparatus according to the present embodiment is an example of an optical writing device that exposes the photoconductors 16. Specifically, as illustrated in FIG. 2, the optical writing device includes a TM sensor 12 (optical detection sensor), an LD 28, a polygon motor 29, and an optical writing controller 20. As illustrated in FIG. 2, the optical writing controller 20 includes a sensor controller 21, a light emission controller 22, a counter 23, a deflection controller 24, a reference value memory 25, a correction value calculation unit 26, and a correction value memory 27.

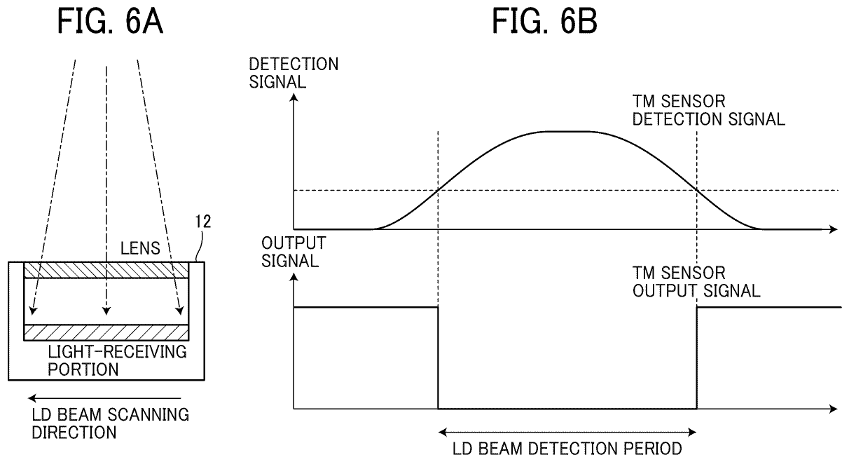

The LD 28 is an example of a light-emitting element that irradiates the photoconductors 16 with light (beam, laser beam). The light emission controller 22 is an example of a light emission control element that controls light emission of the LD 28. While the light emitted from one end to the other end of one surface of the polygon mirror 52 (see FIG. 5), which is an example of a polarizing element, performs scanning in one direction, the light emission controller 22 may control the light amount of the LD 28 to be constant. As a result, a low-cost LD driver without a main-scanning shading function may be adopted, which may contribute to a reduction in manufacturing costs.

Specifically, the light emission controller 22 has a function for controlling turning the LD 28 on and off and adjusting the light emission power of the LD 28. In order to form an electrostatic latent image on the photoconductors 16, the light emission controller 22 transfers a turn-on signal and a turn-off signal of the LD 28 corresponding to the inputted image data at a targeted timing. Hereinafter, the timing for starting the transfer of the turn-on signal and the turn-off signal is referred to as the write start timing.

In order to determine the write start timing, the TM sensor 12 detects the laser beam outputted from the LD 28. The output signal of the TM sensor 12 is inputted to the optical writing controller 20, and resets the internal count value according to the counter 23. The internal count value during image formation is automatically incremented by the counter 23. When the internal count value reaches the predetermined value, the light emission controller 22 starts transfer of the turn-on signal and the turn-off signal of the LD 28 according to the image data.

Here, the predetermined value is a value determined by the sum of a reference value determined on the basis of the arrangement of the photoconductors 16 and the arrangement of the TM sensor 12 (light detection sensor) and a correction value of a shift (main-scanning shift) in the scanning direction of each color. The correction value of the shift in the scanning direction (main-scanning shift) is stored in the correction value memory 27, and is read from the correction value memory 27 before image formation is started. The correction value calculation unit 26 uses the correction value read from the correction value memory 27 and a predetermined reference value (reference value stored in the reference value memory 25) to determine the write start timing.

Note that the correction value stored in the correction value memory 27 is updated at the time of the color matching operation for correcting the color shift between the plurality of colors. With this configuration, by performing the color matching operation, an electrostatic latent image may be formed in a target position of the photoconductors 16, and thus a high-quality image may be formed.

That is, the correction value calculation unit 26 functions as an example of a color shift correction function unit that corrects a color shift between a plurality of colors by adjusting a write start timing from when the TM sensor 12 detects light to when the light emission control by the light emission controller 22, according to the image data, is started. Furthermore, the correction value memory 27 functions as an example of a memory that stores an execution condition of color shift correction by the correction value calculation unit 26 and a correction value (color shift correction value) of the color shift correction. In addition, the correction value calculation unit 26 functions as an example of a detection shift correction function unit that corrects a shift (detection shift) generated when the amount of light incident on the TM sensor 12 fluctuates.

Furthermore, the correction value memory 27 stores the light amount (an example of a first light amount) of the LD 28 when the color shift is corrected by the correction value calculation unit 26. In addition, the correction value calculation unit 26 uses the first light amount and a light amount (an example of a second light amount) determined as the lighting condition of the LD 28 to calculate the detection shift correction value of the detection shift of the TM sensor 12. Further, the correction value calculation unit 26 adds the detection shift correction value to the color shift correction value stored in the correction value memory 27.

Here, the color shift correction includes color matching for performing correction processing of an image, such as main-scanning registration, sub-scanning registration, and overall magnification. In general, in a case where image color matching is to be performed, a method is used in which a color matching pattern formed by toners of respective colors is detected by the TM sensor 12, and a color shift between a plurality of colors is corrected in light of the detection result. The write start timing in the case of forming the color matching pattern is determined by means of a beam light amount in the case of forming the color matching pattern. Further, when the light amount of the beam at the time of forming the color matching pattern changes, the write start timing changes, and the shift of the color matching pattern and the calculated color shift correction value between the plurality of colors are also affected. That is, the color shift correction value between the plurality of colors is combined with the light amount of the beam at the time of forming the color matching pattern in a one-to-one relationship. When the beam light amount changes, an appropriate color shift correction value also changes.

In the present embodiment, in addition to the reference value and the color shift correction value described above, the correction value calculation unit 26 adds a detection shift correction value for correcting the shift (detection shift) in the write start timing caused by the light amount variation of the LD 28. As a result, the first light amount at the time of performing the color shift correction (color matching) is stored, and when an image is printed (when an electrostatic latent image is formed), two light amounts, namely, the second light amount at the time of printing and the first light amount at the time of performing the color matching are used to correct the image write start timing. As a result, a high-quality image may be formed with a low-cost configuration, in addition, the light emission controller 22 may have a function for varying the beam power of the LD 28 at a specific timing in the scanning direction. However, in order to reduce manufacturing costs, this configuration may not be adopted in the present embodiment, and the beam power may be uniform over the entire scanning period.

The polygon motor 29 drives the polygon mirror 52 (see FIG. 5). The deflection controller 24 controls driving of the polygon motor 29.

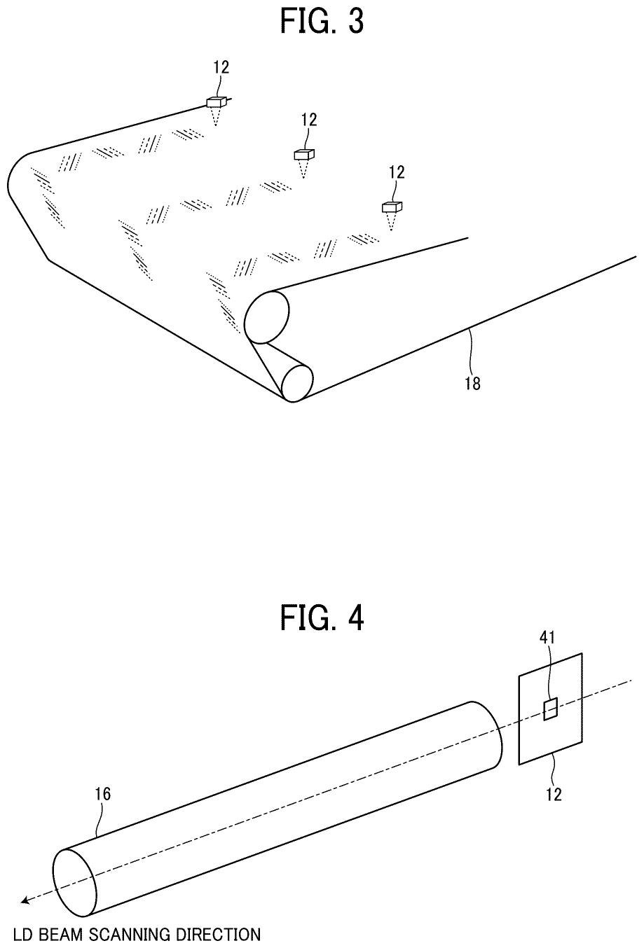

FIG. 3 is a diagram illustrating an example of the correction processing of the write start timing in the color image forming apparatus according to the first embodiment. The electrostatic latent image on the photoconductors 16 is developed using toner (developer) and transferred onto an intermediate transfer member the (intermediate transfer belt 18). A plurality of TM sensors 12 that is provided facing the intermediate transfer belt 18 and that detects toner on the intermediate transfer belt 18 is installed in a direction (main-scanning direction) orthogonal to the conveyance direction of the intermediate transfer belt 18.

At the time of performing color matching, a color matching pattern is formed so as to pass through each TM sensor 12, and the color matching pattern is detected by the TM sensors 12. The correction value calculation unit 26 uses the detection results of the TM sensors 12 to calculate correction values for correcting color shifts such as a registration shift or a magnification shift between a plurality of colors. A color shift correction value at the write start timing is included as one of the correction values.

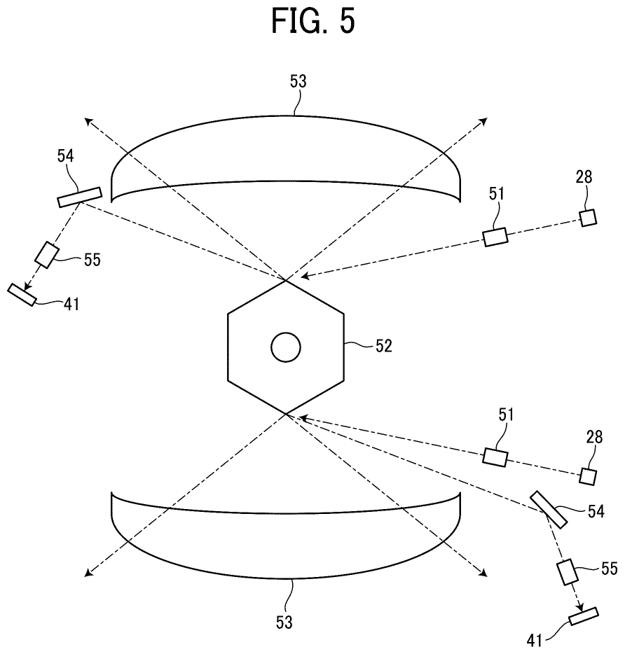

FIG. 4 is a diagram illustrating an example of a synchronization detection plate included in the color image forming apparatus according to the first embodiment. In the present embodiment, the TM sensor 12 is installed on the synchronization detection plate 41, hut a reflective mirror may be placed on a beam path of light from the LD 28, and the synchronization detection plate 41 may be disposed in a completely different position from that of the TM sensor 12.

The TM sensor 12 installed on the synchronization detection plate 41 is disposed on the scanning of the beam emitted from the LD 28. When the photoconductors 16 are scanned once, the TM sensor 12 on the synchronization detection plate 41 detects the beam of the LD 28 immediately before or immediately after the scanning, and outputs a synchronization signal. The write start timing of the photoconductors 16 is determined on the basis of a synchronization signal inputted to the optical writing controller 20.

FIG. 5 is a diagram illustrating an example of a configuration of an optical writing device included in the color image forming apparatus according to the first embodiment. Light emitted from the LD 28 that performs respective scanning of the photoconductors 16 installed for each color is deflected by a surface of the polygon mirror 52 via the lens 51, passes through the fθ lens 53 which is set to face same, and the photoconductors 16 are irradiated with said light. When the polygon mirror 52 rotates, light emitted from the LD 28 scans the photoconductors 16 in one direction, and an electrostatic latent image corresponding to image data is formed on the photoconductors 16.

The angle at which light is reflected varies depending on the rotation angle of the polygon mirror 52, and becomes an angle outside the image region when no light is incident on the fθ lens 53. The light outside the image region is deflected by a mirror 54, and the beam is emitted to the synchronization detection plate 41 via the lens 55. That is, the polygon mirror 52 is a multifaceted reflector and functions as an example of a deflection element that is provided on an emission light path of light from the LD 28, is rotationally driven by a signal inputted from the outside, and deflects the light with which a surface of the reflector is irradiated to scan the photoconductors 16 in one direction.

As described with reference to FIG. 4, because the light sensor (TM sensor 12) is disposed on the synchronization detection plate 41, the TM sensor 12 detects incident light and outputs the light as a synchronization signal to the optical writing controller 20. In the optical writing device mounted on the color image forming apparatus, LDs 28 which correspond to different colors are provided, light is emitted toward the different surfaces of the polygon mirror 52, and the photoconductors 16 of different colors are scanned via different fθ lenses 53. The optical writing device is provided with another synchronization detection plate 41. TM sensors 12 are respectively provided on each of the two synchronization detection plates 41, and the respective TM sensors 12 detect light falling incident from the LDs 28 and output synchronization signals which are different for each color to the optical writing controller 20.

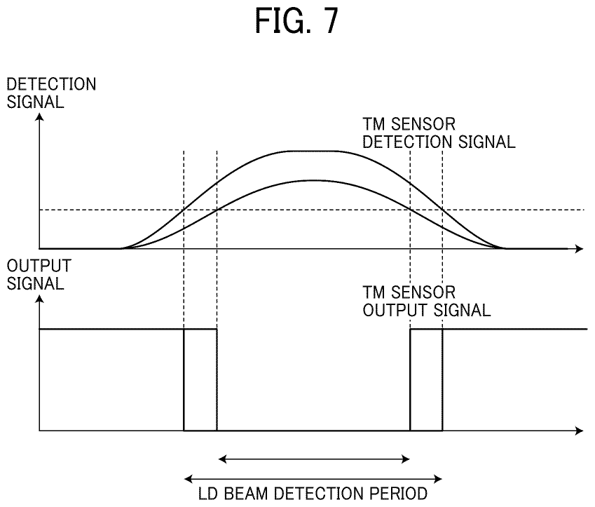

FIG. 6A is a diagram illustrating light incident on a toner marking (TM) sensor of the color image forming apparatus according to the first embodiment. FIG. 6B is a graph illustrating an example of a signal outputted from a TM sensor of the color image forming apparatus according to the first embodiment. In the graph illustrated in FIG. 6B, the vertical axis represents the signal outputted from the TM sensor 12, and the horizontal axis represents time. The TM sensor 12 includes a semiconductor element that generates a current when irradiated with light like a photodiode. In order to improve the accuracy of the light detection by the TM sensor 12, a slit, a lens, and the like for reducing ambient light and narrowing the incident direction of the light may be provided. That is, the TM sensor 12 may have a slit that limits the incident light path of the light from the LD 28. As a result, in a case where the light incident angle is inclined and the S/N ratio has deteriorated, it is possible to correct nonlinear distortion in a configuration for avoiding ambient light.

When the light-receiving portion of the TM sensor 12 is irradiated with the light from the LD 28, a current is generated, and the current is amplified by the built-in operational amplifier circuit, The amplified current then flows to a gain resistor of an adjusted fixed value, and becomes the detection signal of the TM sensor 12. This detection signal is an analog value and is a signal that is difficult to handle without further processing. Therefore, the magnitudes of the detection signals of the TM sensors 12 are compared with each other by means of a comparator, and the signals are converted into digital-value output signals (synchronization signals) of a period in which the beam (LID beam) is detected only in a period in which a certain voltage is exceeded.

The output signals of the TM sensors 12 converted into the digital values are passed to the optical writing controller 20, and it is determined whether the TM sensors 12 have detected the light from the LD 28.

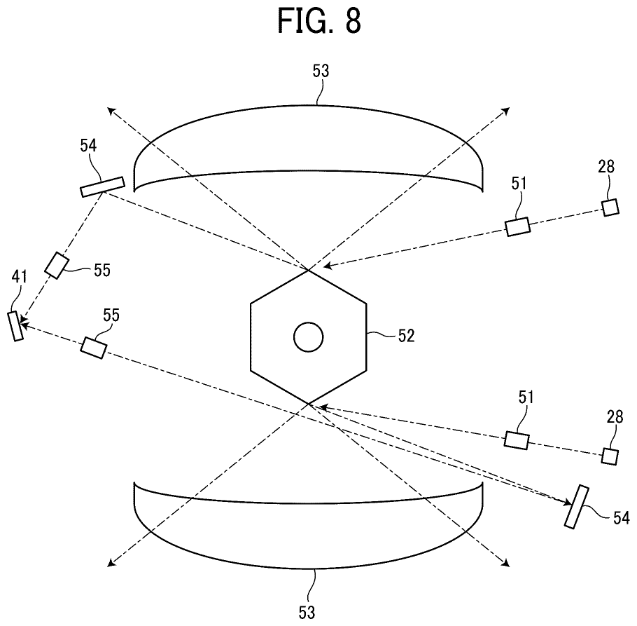

FIG. 7 is a diagram illustrating an example of the relationship between the intensity of the light with which the TM sensor of the color image forming apparatus according to the first embodiment is irradiated, the detection signal, and the output signal. In the graph illustrated in FIG. 7, the vertical axis represents a signal outputted from the TM sensor 12, and the horizontal axis represents time. When the intensity of the light from the LD 28 varies, the detection signal of the TM sensor 12 also varies. When the intensity of the light from the LD 28 is high, the analog detection signal also increases, and when the intensity of the light from the LD 28 is low, the detection signal decreases. As a result, a detection period during which light (an LD beam) represented by the output signal of the TM sensor 12 is detected is widened or shrunk. The falling edge of the detection signal or the rising edge of the detection signal is used as the detection position of the light incident on synchronization detection plate 41. Therefore, if the intensity of the light of the LD 28 is increased or decreased, the position of the edge of the detection signal is chanced, and the write start timing is shifted.

In order to reduce the shift in the write start timing, the following solution methods are conceivable. For example, in a first method, a reference voltage of a comparator of a light sensor is made adjustable and an LD beam detection period is made constant. In addition, a second method is for measuring an LD beam detection period and determining a center position of the LD beam detection period as a detection position, thereby detecting the LD beam regardless of the magnitude of beam power.

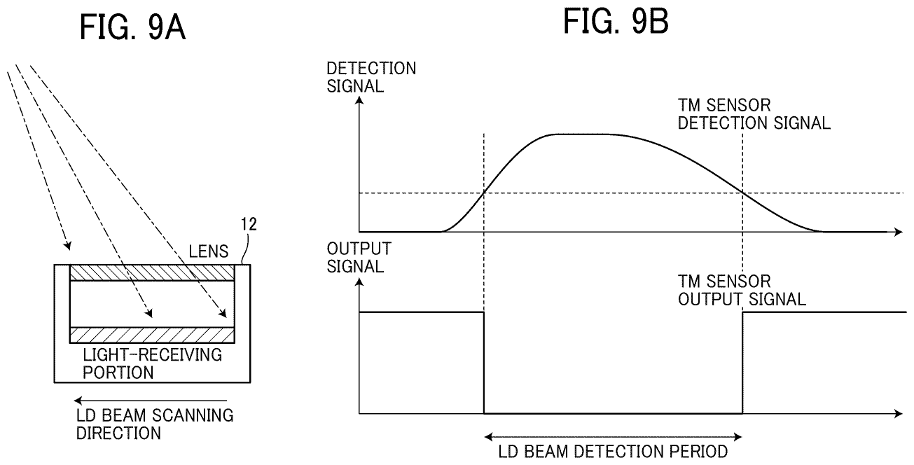

FIG. 8 is a diagram illustrating an example of a configuration of an optical writing device included in the color image forming apparatus according to the first embodiment. in comparison with the optical writing device illustrated in FIG. 5, the optical writing device illustrated in FIG. 8 has the synchronization detection plate 41 integrated into one sheet. Light emitted from two LDs 28 falls incident on one synchronization detection plate 41 at different angles. That is, the optical writing device illustrated in FIG. 8 emits light from a plurality of LDs 28 used for development using different developers, to one TM sensor 12, With this configuration, it is possible to eliminate one synchronization detection plate 41, which contributes to a reduction in the manufacturing costs of the optical writing device.

Further, in order to detect the light of each LD 28, a plurality of TM sensors 12 may be mounted on the synchronization detection plate 41. However, in order to reduce the manufacturing costs of the optical writing device, it is advantageous to reduce the number of TM sensors 12 mounted on the synchronization detection plate 41. From this viewpoint, in the configuration of the optical writing device according to the present embodiment, one TM sensor 12 that detects the light of each LD 28 may be considered to be a common sensor.

In the case of adopting a configuration in which the light of all the LDs 28 is detected by one TM sensor 12, the manufacturing costs of the optical writing device may be reduced, but this configuration is problematic, The light intensity (beam power) of each LD 28 is adjusted to form an electrostatic latent image on the photoconductor 16 corresponding to each color. Because the beams emitted from the LDs 28 having different beam powers are detected by the common TM sensor 12, the method for making the detection period of the light of each LD 28 constant cannot be used.

That is, in a method for adjusting the reference voltage of the comparator so that the light detection period of the LDs 28 is constant as in the above-described first method, the beam power of one LD 28 may be adjusted, but the beam power of the other LD 28 cannot be simultaneously adjusted, and the write start timing of each color cannot be optimized. As a result, image quality deteriorates,

Therefore, in the present embodiment, the first light amount when color matching is performed is stored, and when an image is printed (when an electrostatic latent image is formed), the image write start timing is corrected using two light amounts, namely, the second light amount when printing and the first light amount when color matching is performed. As a result, even with the low-cost configuration illustrated in FIG. 8, it is possible to optimize the write start timing and provide a high-quality image.

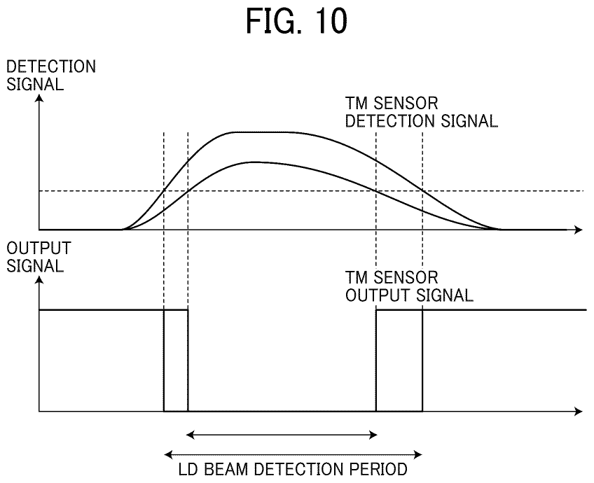

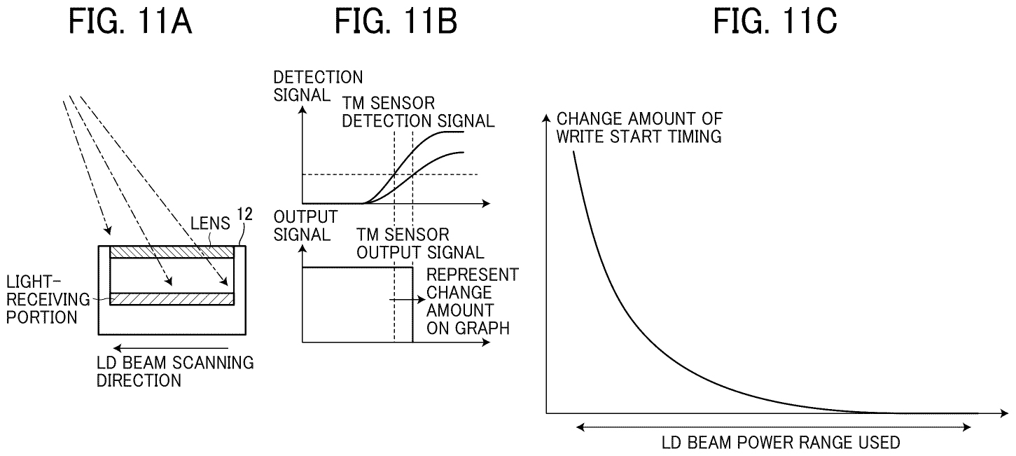

FIG. 9A is a diagram illustrating another example of the light incident on the TM sensor of the color image forming apparatus according to the first embodiment. FIGS. 9B and 10 are diagrams illustrating examples of signals outputted from the TM sensor of the color image forming apparatus according to the first embodiment. In the graphs illustrated in FIGS. 9B and 10, the vertical axis represents a signal outputted from the TM sensor 12, and the horizontal axis represents time. In the example illustrated in FIG. 9A, the angle of light from the LD 28 incident on the TM sensor 12 is inclined in comparison with FIG. 6A. As illustrated in FIG. 8, in a case where a plurality of light beams falls incident on one synchronization detection plate 41 (one TM sensor 12), an incident angle is sometimes generated for each light beam. At this time, the detection signal of the TM sensor 12 may not be bilaterally symmetrical and may have a distorted waveform.

In addition, the example illustrated in FIG. 10 illustrates an aspect of a change in the detection signal and the like in a case where the incident angle of the light from the LD 28 incident on the TM sensor 12 is inclined in comparison with FIG. 7. When the light incident angle is inclined, the detection signal of the TM sensor 12 is distorted instead of being bilaterally symmetrical. At this time, in a case where the beam power of the LD 28 is increased or decreased, the amounts of change on the rising side (left side in the drawing) of the detection signal and the falling side (right side in the drawing) of the detection signal are not uniform. This non-uniformity indicates that the peak position of the light intensity is not at the center of the light detection period of the LD 28. That is, as in the above-described second method, in a method in which the detection period of the light from the LD 28 is measured and a position delayed by ½ of the detection period from the falling edge position of the detection signal is taken as the light detection position, an appropriate position cannot be determined as the peak position, and the write start timing cannot be optimized. As a result, image quality deteriorates.

Therefore, in the present embodiment, the first light amount when color matching is performed is stored, and when an image is printed (when an electrostatic latent image is formed), the write start timing of the image is corrected using two light amounts, namely, the second light amount when printing and the first light amount when color matching is performed. As a result, even with a low-cost configuration like that illustrated in FIG. 8, it is possible to optimize the write start timing and provide a high-quality image.

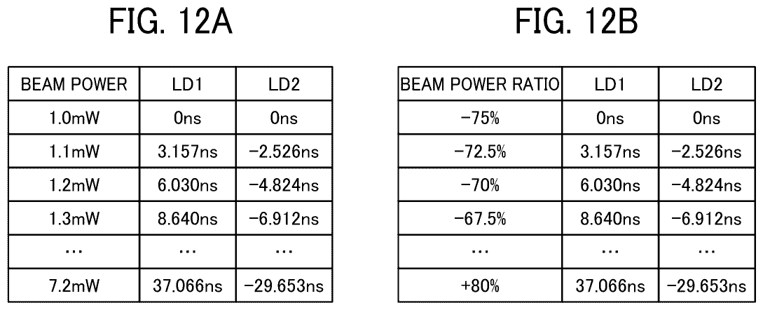

FIG. 11A is a diagram illustrating an example of the light incident on the TM sensor of the color image forming apparatus according to the first embodiment. FIG. 11B is a graph illustrating an example of the signal outputted from the TM sensor of the color image forming apparatus according to the first embodiment. FIG. 11C is a diagram illustrating an example of a change in the write start timing in the color image forming apparatus according to the first embodiment. In the graph of FIG. 11B, the vertical axis represents a signal outputted from the TM sensor 12, and the horizontal axis represents time. Furthermore, in the graph of FIG. 11C, the vertical axis represents the change amount of the write start timing, and the horizontal axis represents the beam power of the LD (LD) 28. When the beam power of the light of the LD 28 incident on the TM sensor 12 mounted on the synchronization detection plate 41 is increased or decreased, the falling edge of the output signal of the TM sensor 12 is shifted, and the image write start timing varies. Therefore, when the change amount of the write start timing is represented on a graph, a non-linear shape is obtained. When the beam power is small, a voltage close to the reference voltage becomes a peak value, and hence the sensitivity to the change in the beam power is high and the change amount is large. When the beam power is large, a voltage close to the reference voltage easily exceeds the reference voltage, and hence the sensitivity to the change in the beam power is low and the change amount is small.

The above-described change amount of the write start timing is tentatively determined using the physical configuration of the incident angle of the light incident on the TM sensor 12, and the shape of the slit, the lens, and the light receiving portion. By using the change amount determined using the physical configuration as an input parameter and by performing an operation to correct the change amount when forming an image, the write start timing may be adjusted at an optimum timing even if the beam power is changed, and a high-quality image may be provided. Therefore, in the present embodiment, a correction table for correcting the change amount may be prepared to correct the shift in the write start timing.

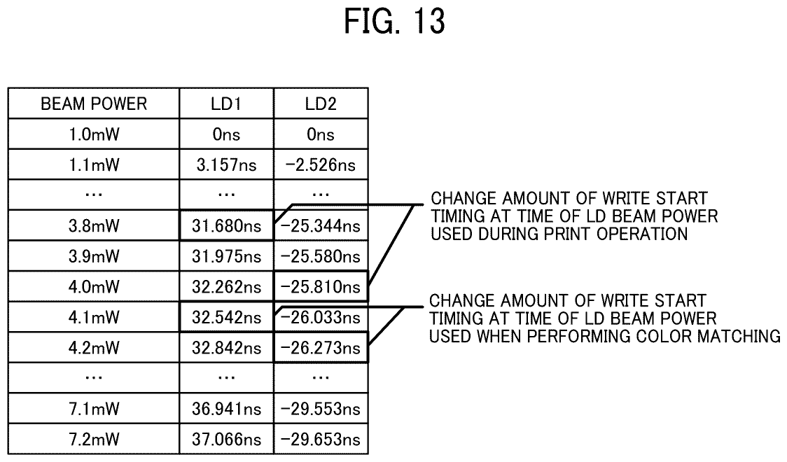

FIGS. 12A and 12B are diagrams illustrating an example of a correction table of the write start timing included in the color image forming apparatus according to the first embodiment. FIG. 12A illustrates an example of a correction table that associates the beam power of the light incident on the TM sensor 12 mounted on the synchronization detection plate 41 with the change amount of the write start timing. That is, the correction table is a table that associates the light amount of the light emitted from the LD 28 with the change amount constituting the shift in the write start timing (that is, the shift of the output signal of the TM sensor 12). The correction table is stored in the correction value memory 27. The correction table is provided for each LD 28 having a different light path.

When one beam power of light incident on the TM sensor 12 is determined, the correction value calculation unit 26 corrects the write start timing according to the correction table. That is, the correction value calculation unit 26 uses the change amount associated with the second light amount (beam power at the time of the print operation or at the time of determining the lighting condition of the LD 28) in the correction table to calculate the detection shift correction value, As a result, the non-linear distortion of the change amount of the write start timing may be corrected by the correction table to provide a high-quality image.

For example, when the beam power of the LD 28 (LD1) is set to 1.3 mW and the beam power of the LD 28 (LD2) is set to 1.1 mW, the correction table indicates a requirement for the write start timing of the LD 1 to be delayed by 8.640 ns and the write start timing of the LD 2 to be advanced by 2.526 ns. By using such a correction table, even if the beam power of each LD 28 is varied, it is possible to provide a high-quality image by reducing the shift in the write timing.

When referring to the correction table, the input value may be the beam power of the light of the ED 28, or may be the ratio (beam power ratio) of the beam power to the reference beam power. That is, the correction table may be a table that associates the beam power ratio with the change amount of the write start timing. In the example illustrated in FIG. 12B, a reference beam power of 4.0 mW is used to calculate the beam power ratio. The reference beam power may be stored for each color during machine assembly. The correction value calculation unit 26 calculates the detection shift correction value on the basis of the change amount associated with the beam power ratio, which is obtained by dividing the second light amount by the reference light amount, in the correction table. When the adjustment range of the beam power is narrow, a method in which the reference beam power is stored is an effective correction method.

Specifically, the correction value memory 27 stores the reference beam power (light amount). The correction value calculation unit 26 reads the reference beam power from the correction value memory 27. The correction value calculation unit 26 then calculates the detection shift correction value by subtracting the change amount associated with the beam power ratio obtained by dividing the first light amount by the reference beam power from the change amount associated with the beam power ratio obtained by dividing the second light amount by the reference beam power.

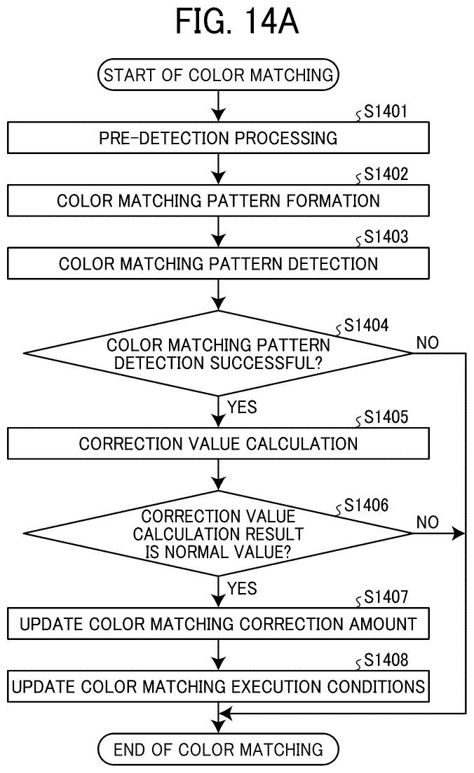

FIG. 13 is a diagram illustrating an example of a method in which a correction table in the color image forming apparatus according to the first embodiment is used. As described with reference to FIGS. 12A and 12B, a table in which the change amount of the write start timing when the beam power of the LD 28 fluctuates may be canceled is a correction table. The color shift between the plurality of colors in the color image forming apparatus is corrected at the time of color matching. Because it is necessary to form a color matching pattern on the intermediate transfer belt 18, the color matching pattern is formed using some kind of beam power for each LD 28.

The write start timing is determined on the basis of the output signal of the TM sensor 12 of the synchronization detection plate 41, and there is no difference between the time the color matching pattern is formed and the time of the print operation, and if the beam power of the LD 28 fluctuates, the shift occurs similarly, When forming the color matching pattern, the timing of the write start timing is shifted according to the beam power, but the correction value calculated for performing color matching in this state also includes the correction value of the write start timing.

Taking FIG. 13 as an example, if the beam power of the Li) 28 (LD 1) at the time of performing color matching is 4.1 mW, the write start timing is shifted by 32.542 ns, but the correction value calculated by the color matching includes the shift of 32.542 ns. Therefore, when the beam power of the LD 1 during the print operation is 4.1 mW, the LD 1 is adjusted to enable an image to be formed in a position which is optimized by color matching.

A method for using the correction table according to the present embodiment is defined as follows, The beam power of each LD 28 is stored as an operation condition at the time of performing color matching, and the write start timing is corrected so as to cancel the difference between the correction amount of the write start timing caused by the beam power at the time of performing printing and the correction amount of the write start timing caused by the beam power at the time of performing the color matching. That is, the correction value calculation unit 26 calculates, as the detection shift correction value, a value obtained by subtracting a change amount (an example of the first detection shift correction amount) of the write start timing determined according to the first light amount at the time of color matching from a change amount (an example of the second detection shift correction amount) of the write start timing determined according to the second light amount at the time of the print operation (at the time of determining the lighting condition of the LD 28). As a result, it is possible to correct, from the beam power at the time of color matching, a color shift when the beam power of the LD 28 fluctuates.

Taking FIG. 13 as an example, when the beam power of the LD I at the time of performing color matching is 4.1 mW and the beam power at the time of the print operation is 3.8 mW, the write start timing of the LD 1 may be corrected by correcting −0.862 ns, which is the difference between the two correction amounts in the correction table, as indicated by the following Expression (1). Further, when the beam power of the LD 2 at the time of performing the color matching is 4.2 mW and the beam power at the time of the print operation is 4.0 mW, the write start timing of the LD 2 may be corrected by correcting 0.463 ns, which is the difference between the two correction amounts in the correction table, as indicated by Expression (2) below.

$$\begin{matrix}[ Expression 1 ] & \\ LD 1 : Correction amount during print operation - correction amount during color matching = 31.68 ns - 32.542 ns = - 0.862 ns & ( 1 )\end{matrix}$$

$$LD 2 : Correction amount during print operation - correction amount during color matching = - 25.81 ns - ( 26.273 ) ns = 0.463 ns \qquad ( 2 )$$

By calculating the correction amount of the write start timing in this manner, it is possible to reduce the shift in the write start timing occurring at the time of image formation and to provide a high-quality image.

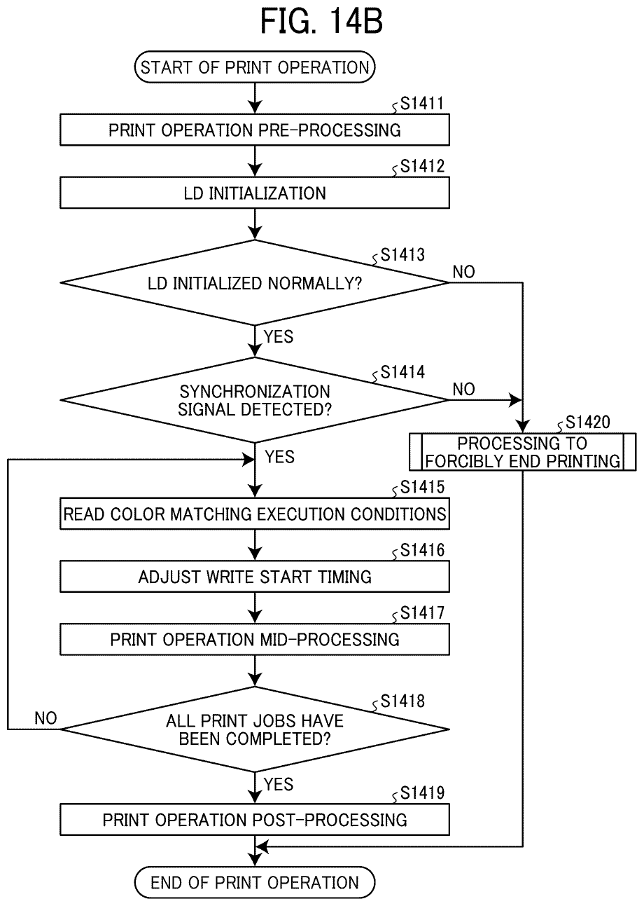

FIG. 14A is a flowchart illustrating an example of a flow of color matching processing in the color image firming apparatus according to the first embodiment. FIG. 14B is a flowchart illustrating an example of a flow of a print operation in the color image forming apparatus according to the first embodiment. The method for correcting the write start timing is processed in the two flowcharts.

First, an example of a flow of color matching processing in a color image forming apparatus will be described. The optical writing controller 20 executes pre-detection processing (step S1401). Specifically, the optical writing controller 20 performs preparation before forming and detecting the color matching pattern. In addition, the optical writing controller 20 adjusts the light emission intensity of the TM sensor 12 while rotating the intermediate transfer belt 18 and the like.

Next, the optical writing controller 20 forms a color matching pattern (step S1402). Specifically, the optical writing controller 20 performs setting relating to formation of a color matching pattern.

Next, the optical writing controller 20 detects a color matching pattern (step S1403). Further, the optical writing controller 20 determines whether or not the detection of the color matching pattern is successful (step S1404). Specifically, the optical writing controller 20 performs the processing relating to the detection of the color matching pattern, and ends the detection processing of the color matching pattern at the time point when all the formed color matching patterns have been detected (step S1404: Yes), and advances to step S1405. On the other hand, in a case where the color matching pattern is not detected (step S1404: No), the optical writing controller 20 ends the color matching processing.

Next, the correction value calculation unit 26 performs processing to calculate a color shift correction value (step S1405). Specifically, the correction value calculation unit 26 uses the detection result of the color matching pattern to calculate a color shift correction value for correcting a shift between colors. Here, the shift between colors includes shifts such as a main-scanning registration shift, a sub-scanning registration shift, a skew shift, a magnification shift, and a partial magnification shift. The shift in the write start timing is included in the main-scanning registration shift among such shifts, and a color shift correction value for correcting the main-scanning registration shift between colors at the time of color matching is calculated,

Next, in a case where the calculated color shift correction value is a normal value (step S1406: Yes), the correction value calculation unit 26 updates the color shift correction value and the first light amount (step S1407), Specifically, the correction value calculation unit 26 updates the color shift correction value and the first light amount which are stored in the correction value memory 27. However, when the color matching is not normally performed (fails), as for the color matching pattern detection and the correction value calculation results and so forth, the processing to update the color shift correction value and. the first light amount is skipped. That is, the first light amount stored in the correction value memory 27 is not updated in cases where color matching is not normally performed.

Next, the correction value calculation unit 26 updates the conditions for performing the color matching processing (step S1408). Specifically, the correction value calculation unit 26 updates the color matching execution conditions stored in the correction value memory 27. Here, the color matching execution conditions include the internal temperature at the time of execution and the beam power of the LD 28, However, when the color matching is not normally performed, as for the color matching pattern detection and the correction value calculation results and so forth, the processing to update the color matching processing execution conditions is skipped.

Next, an example of the flow of the print operation of the color image forming apparatus according to the present embodiment will be described. First, the optical writing controller 20 executes print operation pre-processing (step S1411). Specifically, the optical writing controller 20 performs processing to start up the optical writing device after a print job is entered. Here, the optical writing device startup processing includes LD driver activation, rotation of the polygon motor 29, determination of the beam power of the LD 28 during the print operation, and the like.

Next, the optical writing controller 20 executes processing to initialize the LD 28 (step S1412). Specifically, the optical writing controller 20 initializes the lighting power of the LD 28 to be the target power. The optical writing controller 20 starts synchronized lighting to enable the TM sensors 12 of the synchronization detection plate 41 to detect the beam of the LD 28.

Next, in a case where initialization of the LD 28 is normally performed (step S1413: Yes) and a synchronization signal is detected (step S1414: Yes), the correction value calculation unit 26 reads the color matching execution conditions (step S1415). Specifically, the correction value calculation unit 26 reads the beam power of the LD 28 at the time of performing color matching, which is stored at the time of performing the color matching processing. In a case where the initialization of the LD 28 is not normally performed (step S1413: No) or in a case where the synchronization signal is not detected (step S1414: No), the optical writing controller 20 forcibly ends the print processing (step S1420).

Next, the correction value calculation unit 26 adjusts the write start timing (step S1416). Specifically, the correction value calculation unit 26 refers to the correction table and uses the beam power of the LD 28 at the time of the print operation and the beam power of the LD 28 at the time of performing color matching to adjust the write start timing for each color.

Next, the optical writing controller 20 executes mid-print-operation processing (step S1417), Specifically, the optical writing controller 20 turns on and off the LD 28 according to the image data, and performs processing to form a desired electrostatic latent image on the photoconductors 16.

Thereafter, in a case where all the print jobs have been completed (step S1418: Yes), the optical writing controller 20 executes print operation post-processing (step S1419). Specifically, the optical writing controller 20 performs static elimination of the photoconductors 16 after completion of printing, stops the LD driver, and stops the polygon motor, and so forth.

As described above, with the color image forming apparatus according to the first embodiment, the first light amount when the color shift is corrected is stored, and when an image is to be printed, the image write start timing is corrected using two light amounts, namely, the second light amount when printing and the first light amount when color matching is performed. As a result, a high-quality image may be formed with a low-cost configuration.

### Second Embodiment

The present embodiment is an example in which the write start timing is corrected using a correction curve of a polynomial for determining the change amount of the write start timing. In the following description, descriptions of configurations similar to those of the first embodiment will be omitted.

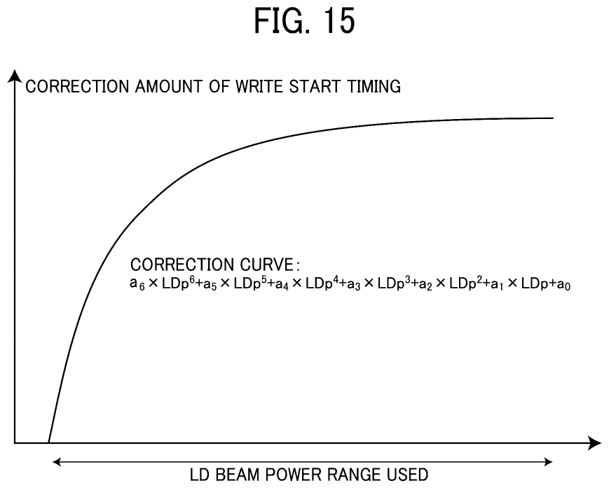

FIG. 15 is a diagram illustrating an example of a method for correcting the write start timing in the color image forming apparatus according to the second embodiment. In FIG. 15, the vertical axis represents the correction amount of the write start timing, and the horizontal axis represents the beam power of the LD (LD) 28, As illustrated in FIGS. 12A, 12B, and 13, the first embodiment proposes a method for using a correction table to adjust the write start timing.

In contrast, in the present embodiment, the correction value calculation unit 26 uses a correction curve of a polynomial for determining the change amount of the write start timing to calculate the correction amount (change amount) of the write start timing. The correction value calculation unit 26 uses a different polynomial correction curve for each color to calculate the correction amount of the write start timing. Specifically, the correction value calculation unit 26 calculates a polynomial approximate curve from each plot point of the correction amount calculated so as to cancel the change amount of the write start timing illustrated in FIG. 11 C, and determines the coefficients a₀ to aₙ (a₆ in the drawing) in advance.

The correction value memory 27 stores the coefficients a₀ to aₙ. In addition, the correction value calculation unit 26 uses the beam power LDp of the LD 28 as an input value, multiplies the input value by the coefficients a₀ to aₙ, and adds up each term from 0 to the n-th power of LDp, to calculate the correction amount of the write start timing.

The correction value memory 27 stores the beam power of each LD 28 as an operation condition at the time of performing color matching. The correction value calculation unit 26 obtains a difference (detection shift correction value) between the correction amount of the write start timing caused by the beam power at the time of performing printing and the correction amount of the write start timing caused by the beam power at the time of performing color matching, and corrects the write start timing so as to cancel the difference.

For example, it is assumed that the correction coefficients are a₀=−42.249, a₁=62.972, a₂=−24.779, a₃=5.0273, a₄=−0.4872, a₅=0.0151, and an a₆=0.0003. When the beam power of the LD 28 (LD 1) at the time of performing color matching is 4.1 mW and the beam power at the time of the print operation is 3.8 mW. the correction value calculation unit 26 calculates the correction amounts of the correction curves as 27.1360 ns and 26.3738 ns, respectively, as indicated by Expressions (3) and (4) below

$$\begin{matrix}[ Expression 2 ] & \\ Correction amount during color matching = 0.0003 \times {4.1}^{6} + 0.0151 \times {4.1}^{5} + 0.4872 \times {4.1}^{4} + 5.0273 \times {4.1}^{3} - 24.779 \times {4.1}^{2} - 62.972 \times 4.1 - 42.249 = 27.136 ns & ( 3 )\end{matrix}$$

$$Correction amount during print operation = 0.0003 \times {3.8}^{6} + 0.0151 \times {3.8}^{5} + 0.4872 \times {3.8}^{4} + 5.0273 \times {3.8}^{3} - 24.779 \times {3.8}^{2} - 62.972 \times 3.8 - 42.249 = 26.3738 ns \qquad ( 4 )$$

The correction value calculation unit 26 calculates, as a detection shift correction value, −0.7622 ns, which is the difference between the two correction amounts, as indicated by Expression (5) below, and, on the basis of the detection shift correction value, corrects the color shift to correct the write start timing of the LD 1.

$$\begin{matrix}[ Expression 3 ] & \\ LD 1 : Correction amount during print operation - correction amount during color matching = 26.3738 ns - 27.136 ns = - 0.7622 ns & ( 5 )\end{matrix}$$

As described above, with the color image forming apparatus according to the second embodiment, in comparison with a case where a correction table is used to correct the write timing with high accuracy, the write start timing may be optimized and a high-quality image may be provided without consuming a large amount of memory area by holding data.

Note that the color image forming apparatus according to the above embodiment has been described with an example in which the color image forming apparatus is applied to a multifunction peripheral having at least two functions among a copy function, a printer function, a scanner function, and a facsimile function. However, the embodiment of the present disclosure may also be applied to any image forming apparatus such as a copier, a printer, a scanner device, or a facsimile device.

Aspects of the present disclosure are, for example, as follows.

### First Aspect

An electrophotographic color image forming apparatus develops an electrostatic latent image on a photoconductor with a developer to form an image. The color image forming apparatus includes the photoconductor and an optical writing device to expose the photoconductor. The optical writing device includes: a light-emitting element to irradiate the photoconductor with light; a light emission control element to control light emission of the light-emitting element; a deflector element that is a multifaceted reflector disposed on an emission light path of the light from the light-emitting element, the reflector to be rotated by a signal inputted from an external device and to deflect the light with which a surface of the reflector is irradiated to scan the photoconductor with the light in one direction; a synchronization detection element to detect a write start timing of the electrostatic latent image with the light with which the photoconductor is irradiated; a color shift correction function unit to correct a color shift between a plurality of colors by adjusting the write start timing from when the synchronization detection element detects light to when light emission control by the light emission control element according to image data is started; a memory that stores an execution condition for correcting the color shift and a color shift correction value for correcting the color shift; and a detection shift correction function unit to correct a detection shift generated when a light amount of light incident on the synchronization detection element fluctuates. The memory stores a first light amount of the light-emitting element when the color shift is corrected. The detection shift correction function unit uses the first light amount and a second light amount determined as a lighting condition of the light-emitting element to calculate a detection shift correction value of the detection shift of the synchronization detection element, and adds the detection shift correction value to the color shift correction value.

### Second Aspect

In the color image forming apparatus according to the first aspect, the light emission control element controls a light amount of the light-emitting element to be constant while light emitted from one end to the other end of one surface of the deflection element scans the photoconductor in one direction.

### Third Aspect

The color image forming apparatus according to the first or second aspect includes a plurality of light-emitting elements, including the light-emitting element, for development using different developers. The optical writing device emits light from the plurality of light-emitting elements to the synchronization detection element that is a single synchronization detection element.

### Fourth Aspect

In the color image forming apparatus according to any one of the first aspect to the third aspect, the memory stores a correction table that associates a light amount of light emitted from the light-emitting element with a change amount of the write start timing. The detection shift correction function unit calculates the detection shift correction value, using a change amount of the write start timing associated with the second light amount in the correction table.

### Fifth Aspect

In the color image forming apparatus according to any one of the first aspect to the third aspect, the detection shift correction function remit calculates the detection shift correction value, using a detection shift correction curve of a polynomial for determining a. change amount of the write start timing. The memory stores a coefficient of the polynomial.

### Sixth Aspect

In the color image forming apparatus according to any one of the - first to - fifth aspects, the synchronization detection element has a slit to limit an incident light path of light from the light-emitting element.

### Seventh Aspect

In the color image forming apparatus according to the fifth aspect, the detection shift correction function unit calculates the detection shift correction value, using the polynomial that is different for each of light-emitting elements that irradiate the synchronization detection element with light.

### Eighth Aspect

In the color image forming apparatus according to any one of the first to seventh aspects, the detection shift correction function unit calculates, as the detection shift correction value, a value obtained by subtracting a first detection shift correction amount determined according to the first light amount from a second detection shift correction amount determined according to the second light amount.

### Ninth Aspect

In the color image forming apparatus according to any one of the first to seventh aspects, the memory stores a correction table that associates a ratio obtained by dividing a light amount emitted from the light-emitting element by a reference light amount with a change amount of the mite start timing. The detection shift correction function unit calculates the detection shift correction value on the basis of a change amount of the write start timing associated with a ratio obtained by dividing the second light amount by the reference light amount in the correction table.

### Tenth Aspect

In the color image forming apparatus according to the ninth aspect, the memory stores the reference light amount. The detection shift correction function unit reads the reference light amount from the memory in a case of calculating the detection shift correction value, and calculates the detection shift correction value by subtracting a change amount of the write start timing associated with a ratio obtained by dividing the first light amount by the reference light amount from the change amount associated with the ratio obtained by dividing the second light amount by the reference light amount.

### Eleventh Aspect

In the color image forming apparatus according to any one of the first to tenth aspects, the first light amount stored in the memory is not updated when color matching is not normally performed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry Which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may he any hardware disclosed herein or otherwise known Which is programmed or configured to carry out the recited functionality. When the hardware is a processor which may be considered a type of circuitry, the circuitry, means, or units are a combination of hardware and software, the software being used to configure the hardware and/or processor.

1. An electrophotographic color image forming apparatus to develop an electrostatic latent image with a developer to form an image, the apparatus comprising:
a photoconductor to bear the electrostatic latent image to be developed with the developer; and
an optical writing device to expose the photoconductor,
the optical writing device including:
a light-emitting element to irradiate the photoconductor with light;
a light emission control element to control light emission of the light-emitting element;
a deflector element that is a multifaceted reflector disposed on an emission light path of the light from the light-emitting element, the reflector to he rotated by a signal inputted from an external device and deflect the light with which a surface of the reflector is irradiated to scan the photoconductor with the light in one direction;
a synchronization detection element to detect a write start timing of the electrostatic latent image with the light with which the photoconductor is irradiated;
a memory that stores an execution condition for correcting a color shift between a plurality of colors and a color shift correction value for correcting the color shift, the memory that stores a first light amount of the light-emitting element when the color shift is corrected; and
processing circuitry configured to correct the color shift by adjusting the write start timing from when the synchronization detection element detects light to when light emission control by the light emission control element according to image data is started, and to correct a detection shift generated when a light amount of light incident on the synchronization detection element fluctuates,
the processing circuitry configured to calculate a detection shift correction value of the detection shift of the synchronization detection element, using the first light amount and a second light amount determined as a lighting condition of the light-emitting element, and add the detection shift correction value to the color shift correction value.

2. The color image forming apparatus according to claim 1,
wherein the light emission control element controls a light amount of the light-emitting element to be constant while light emitted from one end to the other end of one surface of the deflection element scans the photoconductor in one direction.

3. The color image forming apparatus according to claim 1, further comprising a plurality of light-emitting elements, including the light-emitting element, for development using different developers,
wherein the optical writing device emits light from the plurality of light-emitting elements to the synchronization detection element.

4. The color image forming apparatus according to claim 1,
wherein the memory stores a correction table that associates a light amount of light emitted from the light-emitting element with a change amount of the write start timing, and
the processing circuitry calculates the detection shift correction value, using a change amount of the write start timing associated with the second light amount in the correction table.

5. The color image forming apparatus according to claim 1,
wherein the processing circuitry calculates the detection shift correction value, using a detection shift correction curve of a polynomial for determining a change amount of the write start timing, and
the memory stores a coefficient of the polynomial.

6. The color image forming apparatus according to claim 1,
wherein the synchronization detection element has a slit to limit an incident light path of light from the light-emitting element.

7. The color image forming apparatus according to claim 5,
wherein the processing circuitry calculates the detection shift correction value, using the polynomial that is different for each of light-emitting elements that irradiate the synchronization detection element with light.

8. The color image forming apparatus according to claim 1,
wherein the processing circuitry calculates, as the detection shift correction value, a value obtained by subtracting a first detection shift correction amount determined according to the first light amount from a second detection shift correction amount determined according to the second light amount.

9. The color image forming apparatus according to claim 1,
wherein the memory stores a correction table that associates a ratio obtained by dividing a light amount emitted from the light-emitting element by a reference light amount with a change amount of the write start timing, and
the processing circuitry calculates the detection shift correction value, based on a change amount of the write start timing associated with a ratio obtained by dividing the second light amount by the reference light amount in the correction table.

10. The color image forming apparatus according to claim 9,
wherein the memory stores the reference light amount, and
the processing circuitry reads the reference light amount from the memory in a case of calculating the detection shift correction value, and calculates the detection shift correction value by subtracting a change amount of the write start timing associated with a ratio obtained by dividing the first light amount by the reference light amount from the change amount associated with the ratio obtained by dividing the second light amount by the reference light amount.

11. The color image forming apparatus according to claim 1,
wherein the processing circuitry skips updating the first light amount stored in the memory when color matching fails.
